(19) United States
(12) Patent Application Publication
(10) Pub. No.: US 2011/0083835 A1
(43) Pub. Date: Apr. 14, 2011

(54) Heat-dissipating structure and method for fabricating the same

(76) Inventors: Ying-Tung Chen, Taoyuan (TW); Wei-En Chen, Taipei (TW)

(21) Appl. No.: 12/592,964

(22) Filed: Dec. 4, 2009

(30) Foreign Application Priority Data
Oct. 8, 2009 (TW) 098134071

(51) Int. Cl. F28F 21/02; B32B 37/06; F28F 21/00; F28F 21/08

(52) U.S. Cl. 165/185; 156/62.2

(57) ABSTRACT

Provided are a heat-dissipating structure and a method for fabricating the same so as for the heat-dissipating structure thus fabricated to dissipate heat from the heat-generating portion of an electronic device. The heat-dissipating structure includes a metal base and a carbon composite layer. The carbon composite layer is formed on the metal base and includes metal particles and carbon particles sintered together. The heat-dissipating structure is more effective in dissipating heat than a conventional vapor chamber or heat spreader. The heat-dissipating structure further includes a carbon composite layer and a metal plate with high thermal conductivity. The heat-dissipating structure is attachable to a heat-generating electronic component to facilitate heat exchange therebetween and thereby enhance heat dissipation.

### BACKGROUND OF THE INVENTION

1. Field of the Invention

The present invention relates to heat-dissipating technology, and more particularly, to a heat-dissipating structure for use with a heat-generating source inside an electronic device to quickly absorb heat and release the heat to the environment and a method for fabricating the same.

2. Description of the Prior Art

Many components used in electronic devices generate considerable heat as an undesirable result of operation that can damage such components (or others) if the heat is not continually removed. Examples abound, such as central processing units (CPUs), laser diodes, light-emitting diodes, and microwave sources. The power consumed by electronic components generally increases with their performance; hence, there is a trend for such components to produce more and more heat, and such high heat is increasingly difficult to effectively remove. As a result, such heat-generating components are operating closer to their thermal tolerance limit and are thereby more likely to be damaged than ever before.

Take CPUs as an example, most existing CPUs can get by with copper heat-dissipating fins. But this is not the case for many of the newer high-performance CPUs, because such CPUs contain many more transistors and generate more heat, and heat up nearly instantaneously. Hence, the dense circuitry of a high-performance CPU equipped only with copper heat-dissipating fins is vulnerable.

A conventional heat-dissipating structure in wide use comprises a heat pipe or a vapor chamber for dissipating heat. The heat pipe is provided therein with a copper mesh so as to be porous. The heat pipe is further provided therein with an evaporation portion. The evaporation portion is above a concentrated heat source (particularly a CPU). The heat pipe works in the same way as a thermal siphon heat pipe except that the heat pipe differs from the thermal siphon heat pipe in the way that the working fluid returns to the evaporation portion. In the heat pipe, the working fluid is delivered to the evaporation portion so as for the working fluid to be evaporated, and the delivery of the working fluid occurs only in the presence of a porosity structure that enables the working fluid to be delivered to the evaporation portion by capillarity. Upon its arrival at the evaporation portion, the working fluid is evaporated. Afterward, the evaporated gaseous working “fluid” condenses back into liquid. The aforesaid cycle repeats such that the heat pipe works continuously to effectuate heat dissipation.

A conventional heat pipe or a conventional vapor chamber is formed therein with a copper mesh so as to be porous. Although copper is effective in dissipating heat, copper meshes and other devices with functions equivalent thereto, such as copper grooves and sintered copper powder, fail to efficiently dissipate the heat generated by high-performance, high-power CPUs. To meet the aforesaid demand, heat-dissipating structures made of composite materials capable of efficient thermal conduction have been developed over the years. To quickly dissipate heat from electronic devices, quickly remove high heat instantaneously generated, and efficiently effectuate heat dissipation, the composite materials must have a high thermal conductivity, low density, and low coefficient of expansion. In this regard, diamond composites are the best candidates. Diamond composites are good heat-dissipating materials because diamond composites are of higher thermal conductivity than pure copper and other materials and yet of lower density and with a lower coefficient of expansion than aluminum and copper.

FIG. 1A and FIG. 1B depict structural views of a heat transfer structure during manufacture as disclosed in Taiwanese Patent Application 093117360, wherein industrial diamonds are used as the primary material from which the heat transfer structure is made. As shown in the drawings, in an embodiment, a heat transfer structure 10 during manufacture comprises: a cylindrical container 11 filled with a plurality of diamond particles 12 and an oxygen-free high-conduction copper element 13 disposed on top of the plurality of diamond particles 12. In a high-temperature, high-pressure operating environment, a pressure of 2000 tons is exerted upon the oxygen-free high-conduction copper element 13, and electric current is applied to the oxygen-free high-conduction copper element 13 to heat up the oxygen-free high-conduction copper element 13 to a high temperature above 1150° C. such that the oxygen-free high-conduction copper element 13 melts at the high temperature. The molten copper from the oxygen-free high-conduction copper element 13 permeates the plurality of diamond particles 12. Again, high pressure is applied so as to couple the oxygen-free high-conduction molten copper and the plurality of diamond particles 12 together. Furthermore, a small amount of metal powder, such as zirconium or silver, is added to the coupled-together oxygen-free high-conduction copper and the diamond particles 12 to increase permeability or thermal conductivity with a view to forming a cylindrical heat transfer block.

In that the heat transfer structure 10 is formed by coupling diamond particles and copper powder together, the heat transfer structure 10 thus formed is of high thermal conductivity. Diamond is a good heat conduction material because diamond has a thermal conductivity of up to 2300 W/m·K, which is about six times that of copper and much higher than that of other metals.

However, the prior art does have a drawback. Despite its high thermal conductivity, the heat transfer structure 10 has to be fabricated in a high-temperature, high-pressure environment and thus incurs high costs. Also, it is rather difficult to control the temperature and pressure in the high-temperature, high-pressure environment, which is important because excessively high temperature and pressure is detrimental to the diamond particles 12. The control of temperature and pressure not only increases costs but also complicates the fabrication process. Also, the heat transfer structure 10 is a solid structure formed by compression; hence, no space or slits exist inside the heat transfer structure 10. Therefore, the heat transfer structure 10 does not work in an environment configured for fluid communication, not to mention the fact that the heat transfer structure 10 is unfit for heat dissipation in the aforesaid environment.

Accordingly, it is imperative to provide a heat-dissipating technique with an enhanced heat-dissipating effect, and provide a structurally simple, easy-to-make, and cost-cutting heat-dissipating structure, so as to overcome the above drawbacks of the prior art.

### SUMMARY OF THE INVENTION

In view of the aforesaid drawbacks of the prior art, it is an objective of the present invention to provide a heat-dissipating structure and a method for fabricating the same for enhancing heat dissipation.

Another objective of the present invention is to provide an easy-to-make heat-dissipating structure and a method for fabricating the same.

Yet another objective of the present invention is to provide a cost-cutting heat-dissipating structure and a method for fabricating the same.

A further objective of the present invention is to provide a structurally simple heat-dissipating structure and a method for fabricating the same.

To achieve the above and other objectives, the present invention provides a heat-dissipating structure comprising: a carbon composite layer comprising a plurality of metal particles and carbon particles sintered together, wherein: the carbon particles are of irregular shape; a volumetric ratio of the metal particles to the carbon particles is greater than 1; and a diametric ratio of the carbon particles to the metal particles is predetermined.

To achieve the above and other objectives, the present invention further provides a heat-dissipating structure comprising: a metal base; and a carbon composite layer formed above the metal base comprised of a plurality of metal particles and carbon particles sintered together with a porosity structure formed therebetween, wherein: the carbon particles are of irregular shape; a volumetric ratio of the metal particles to the carbon particles is greater than 1; and a diametric ratio of the carbon particles to the metal particles is predetermined.

In a preferred embodiment, the heat-dissipating structure comprises a metal base and a carbon composite layer. The metal base is provided therein with a chamber. The carbon composite layer comprises a plurality of metal particles and carbon particles sintered together. The carbon composite layer is formed on the inner wall of the chamber of the metal base. The carbon particles are of irregular shape. The volumetric ratio of the metal particles to the carbon particles is greater than 1. The diametric ratio of the carbon particles to the metal particles is predetermined.

The present invention further provides a method for fabricating a heat-dissipating structure, comprising the steps of: sintering a plurality of metal particles and a plurality of carbon particles together to form a carbon composite layer; and coupling the carbon composite layer thus sintered and a metal base together by sintering, wherein the carbon particles are of irregular shape, a volumetric ratio of the metal particles to the carbon particles is greater than 1 and a diametric ratio of the carbon particles to the metal particles is predetermined.

Regarding the heat-dissipating structure, the volumetric ratio of the metal particles to the carbon particles ranges between 4:1 and 8:1, and is preferably 6:1. The diametric ratio of the metal particles to the carbon particles is 1:1±15% and preferably 1:1±10%. The carbon composite layer is provided therein with a porosity structure. In an embodiment, the carbon particles are from diamond or graphite, and the metal particles are made of copper, aluminum, silver, or nickel. The carbon particles have a diameter between 1 μm and 2 mm, preferably between 50 μm and 180 μm, and more preferably between 90 μm and 110 μm.

Unlike the prior art, the present invention provides a heat-dissipating structure and a method for fabricating the same such that a plurality of metal particles and carbon particles are coupled to each other by sintering to thereby form a carbon composite layer. According to the present invention, the carbon particles are conducive to enhancement of heat transfer and heat dissipation, and a porosity structure is formed inside the carbon composite layer. The heat-dissipating structure and the method for fabricating the same according to the present invention are applicable to a fluid heat-dissipating mechanism whereby the porosity structure provides capillarity and flow space for a working fluid so as to enhance heat dissipation. Accordingly, the present invention overcomes drawbacks of the prior art, namely inefficient heat dissipation, high production costs, poor control of the fabrication process, and a complicated structure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A and FIG. 1B are representative views of a heat transfer structure during manufacture disclosed in Taiwanese Patent Application 093117360;

FIG. 2 is a structural cross-sectional view of a first embodiment of a heat-dissipating structure according to the present invention;

FIG. 3 is a structural cross-sectional view of a second embodiment of the heat-dissipating structure according to the present invention;

FIG. 4 is a structural cross-sectional view of a third embodiment of the heat-dissipating structure according to the present invention;

FIG. 5 is a structural cross-sectional view of an operating mechanism for the heat-dissipating structure according to the present invention;

FIG. 6 is a perspective view of a fourth embodiment of the heat-dissipating structure according to the present invention;

FIG. 7 is a flow chart of a method for fabricating the heat-dissipating structure according to the present invention;

FIG. 8 is a block diagram of constituent elements for use with the method for fabricating the heat-dissipating structure according to the present invention;

FIG. 9A and FIG. 9B are photomicrographs of the carbon composite layer of a heat-dissipating structure according to the present invention when the carbon composite layer is observed with an optical microscope at 300× magnifying power;

FIG. 10 is a graph of thermal resistance against input heat power for a CK-3 diamond-containing composite layer and a YK-J diamond-containing composite layer;

FIG. 11A and FIG. 11B are photomicrographs of the carbon composite layers of coarse copper powder of 70-150 mesh for use with the heat-dissipating structure according to the present invention when the carbon composite layers are observed with optical microscopes at 50× and 300× magnifying power, respectively;

FIG. 12A and FIG. 12B are photomicrographs of the carbon composite layers of fine copper powder of 150-325 mesh for use with the heat-dissipating structure according to the present invention when the carbon composite layers are observed with optical microscopes at 50× and 300× magnifying power, respectively; and

FIG. 13 is a graph of thermal resistance against input heat power for four vapor chambers made of different materials.

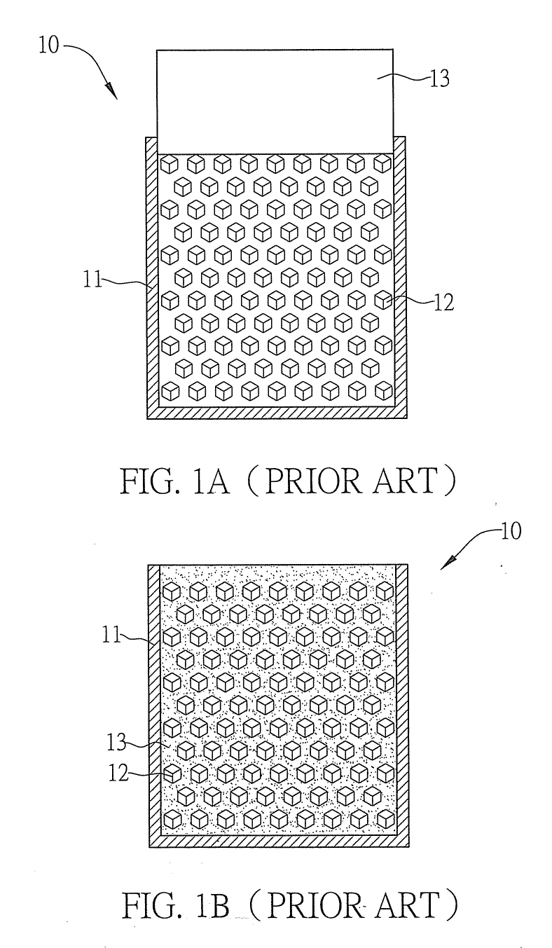

### DETAILED DESCRIPTION OF THE PREFERRED EMBODIMENTS

Implementation of the present invention is hereunder illustrated with specific embodiments such that persons skilled in the art can readily understand other advantages and effects of the present invention by making reference to the disclosure contained in the specification. Other implementations and/or applications of the present invention are achievable by making reference to differing embodiments. Various modifications and changes can be made to the details described in the specification based on different viewpoints and applications without departing from the spirit embodied in the present invention.

The present invention is hereunder illustrated with embodiments and drawings. The present invention provides a heat-dissipating structure positioned above a component that generates heat in operation, such as a central processing unit (CPU) in an electronic device or a light-emitting diode (LED) that generates heat in operation, so as to transfer and dissipate heat quickly. In practice, the form, quantity, and scale of the components of the heat-dissipating structure are not limited by the included drawings but are changeable as needed.

Referring to FIG. 2, a structural cross-sectional view of a first embodiment of a heat-dissipating structure is shown according to the present invention. As shown in the drawing, in the first embodiment of the present invention, a heat-dissipating structure 20 comprises a carbon composite layer 21, the carbon composite layer 21 being formed by mixing and sintering together a plurality of carbon particles 211 and a plurality of metal particles 213.

The carbon particles 211 are of irregular shape. The volumetric ratio of the metal particles 213 to the carbon particles 211 is greater than 1. The diametric ratio of the carbon particles 211 to the metal particles 213 is predetermined. In this embodiment, the volumetric ratio of the metal particles 213 to the carbon particles 211 ranges between 4:1 and 8:1 and is preferably 6:1, and the diametric ratio of the metal particles 213 to the carbon particles 211 is 1:1±15% and preferably 1:1±10%.

In this embodiment, the sintering of the carbon particles 211 and the metal particles 213 together is achievable by a conventional powder metallurgy process or by a process that combines conventional powder metallurgy with metal injection molding. The process involves mixing the carbon particles 211 with a polymer binder, heating the mixture of the carbon particles 211 and the polymer binder until the mixture becomes as fluid as plastic, shaping the fluid mixture into components of intricate shape by an injection molding machine, debindering a green tape resulting from injection molding to remove the polymer binder, and sintering the debindered green tape to obtain high-density sintered components of satisfactory mechanical and physical properties. Owing to their irregular shape, the carbon particles 211 have a relatively large surface area that gives a relatively great porosity to the carbon particles 211 after the sintering thereof. The relatively great porosity of the carbon particles 211 is conducive to heat dissipation. The irregular shape of the metal particles 213 enables the metal particles 213 to be engaged with each other when sintered. Fusion of the metal particles 213 and the carbon particles 211 seldom takes place. It is only when the volumetric ratio of the metal particles 213 to the carbon particles 211 ranges between 4:1 and 8:1 that the metal particles 213 outnumber the carbon particles 211 by a margin wide enough for the metal particles 213 to have a tight grip on the carbon particles 211, such that the metal particles 213 and the carbon particles 211 can be sintered together and engaged with each other. Where the volumetric ratio of the metal particles 213 to the carbon particles 211 is 6:1, the metal particles 213 and the carbon particles 211 are sintered together to exhibit the highest degree of structural strength (thus minimizing loss of said carbon particles 211 during processing) and optimize heat dissipation. As mentioned earlier, the predetermined diametric ratio of the metal particles 213 to the carbon particles 211 is 1:1±15% and preferably 1:1±10%, which is necessary because the carbon particles 211 differ from the metal particles 213 in specific gravity and surface area. Narrowing down the difference in diameter between the carbon particles 211 and the metal particles 213 in a predetermined manner prevents segregation of otherwise separable said metal particles 213 and carbon particles 211.

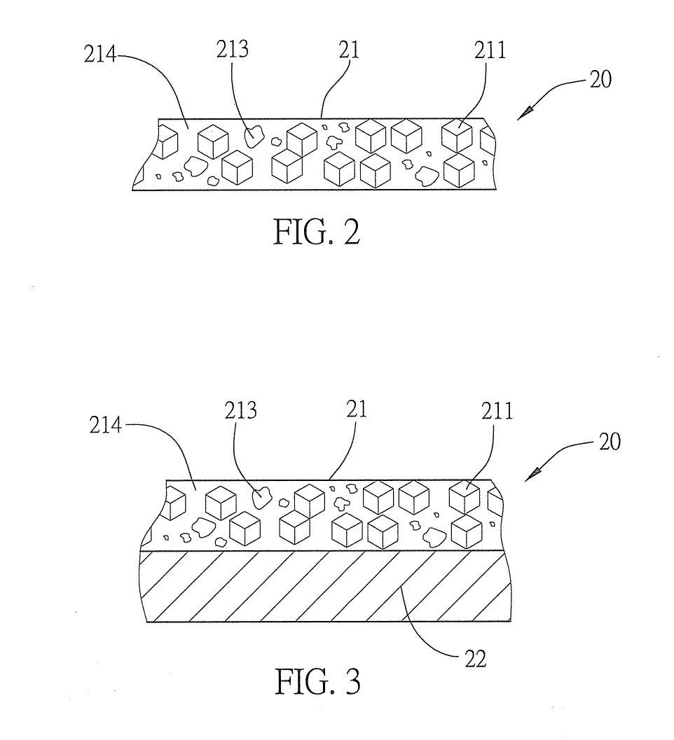

FIG. 3 depicts a structural cross-sectional view of a second embodiment of the heat-dissipating structure according to the present invention. As shown in the drawing, the heat-dissipating structure 20 comprises a metal base 22 and the carbon composite layer 21. The metal base 22 is made of metal of high thermal conductivity, such as copper, aluminum, or nickel. The carbon composite layer 21 is formed by sintering a plurality of metal particles 213 and a plurality of carbon particles 211 together. The sintering of the metal particles 213 and carbon particles 211 causes the surfaces and edges of the metal particles 213 and carbon particles 211 to melt; hence, not only are the metal particles 213 and the carbon particles 211 coupled together, but a porosity structure 214 is provided between the metal particles 213 and the carbon particles 211. In this embodiment, the carbon particles 211 are diamonds, and the metal particles 213 are made of copper, aluminum, silver, or nickel. In this embodiment, the carbon particles 211 are exemplified by industrial diamonds and the metal particles 213 by copper.

Industrial diamonds and copper have thermal conductivity as high as 2300 W/m. K and 401 W/m. K, respectively, that is, much higher than that of other metals. Hence, the present invention provides a heat-dissipating structure made of composite materials of high thermal conductivity that has high thermal conduction. The diameter of the carbon particles 211 ranges between 1 μm and 2 mm, preferably between 50 μm and 180 μm, and more preferably between 90 μm and 110 μm.

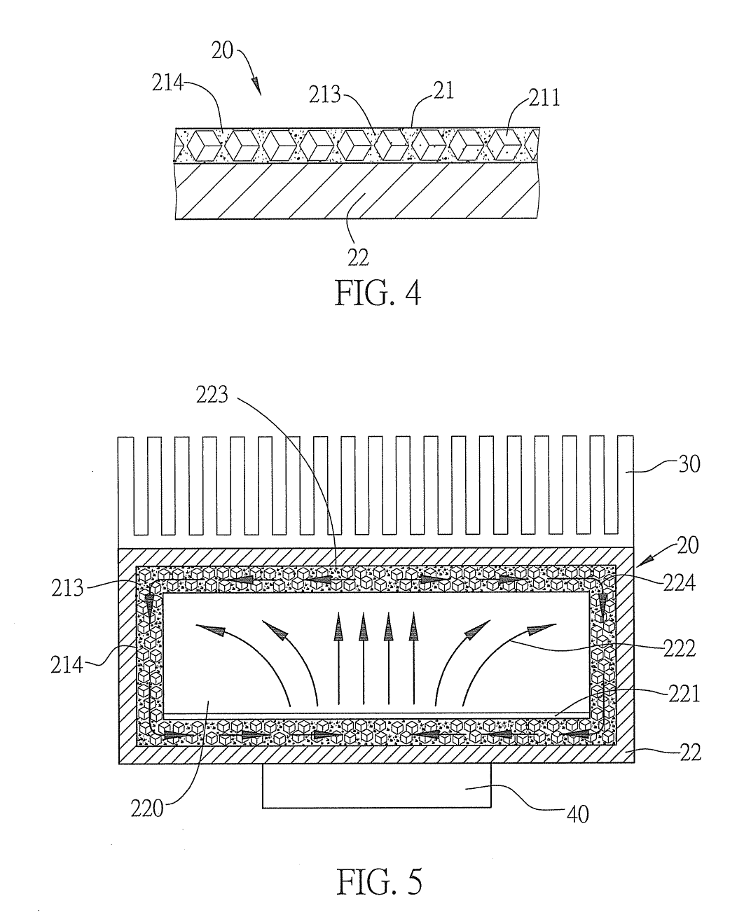

FIG. 4 depicts a structural cross-sectional view of a third embodiment of the heat-dissipating structure according to the present invention. As shown in the drawing, in the third embodiment of the present invention, the heat-dissipating structure 20 also comprises a metal base 22 and a carbon composite layer 21. Unlike the first and second embodiments, in the third embodiment, the carbon composite layer 21, which is still formed by sintering a plurality of carbon particles 211 and a plurality of metal particles 213 together, appears in the form of a single layer coupled to the metal base 22. Nonetheless, in other embodiments, the carbon composite layer 21 coupled to the metal base 22 can be either bilayered or multilayered, and sintered together. The heat-dissipating structure 20 features enhanced heat dissipation and enhanced applicability, and the structure can replace conventional heat-dissipating graphite platelets for the following reasons: the uniform size of the carbon particles 211 of the carbon composite layer 21; the high and omni-directional thermal conductivity of the carbon particles 211; and the large surface area of the carbon particles 211.

FIG. 5 depicts a structural cross-sectional view of an operating mechanism for a heat-dissipating structure according to the present invention. As shown in the drawing, to apply the heat-dissipating structure 20 of the present invention, heat-dissipating fins 30 may be disposed above the heat-dissipating structure 20. The heat-dissipating fins 30 are attached to the metal base 22 from above, so as to enhance heat dissipation. Of course, in other embodiments, it is feasible to replace the heat-dissipating fins 30 with a condenser or any other equivalent device. In this embodiment, the metal base 22 is positioned above a heat-generating source, and the heat-generating source is a central processing unit 40 in an electronic device or any other heat-generating assembly. This embodiment is exemplified by the central processing unit 40. The central processing unit 40 generates high heat during operation and thus raises the temperature. The heat-dissipating structure 20 of the present invention is disposed immediately above the central processing unit 40 to thereby enhance heat dissipation.

To use the heat-dissipating structure 20 of the present invention, it is feasible to form inside the metal base 22 (and carbon composite layer 21) a chamber 220 such that the chamber 220 is a partial vacuum and hermetically sealed. The chamber 220 contains a superconductor-dielectric 221. The superconductor-dielectric 221 is usually deionized water or alcohol. Heat generated by the central processing unit 40 during operation is passed by the metal base 22 to the carbon composite layer 21. Upon its rapid absorption by the carbon composite layer 21, the heat is transferred to the superconductor-dielectric 221. The superconductor-dielectric 221 undergoes liquid-phase vaporization to thereby produce high-temperature steam 222. The high-temperature steam 222 thus produced fills the chamber 220 completely. The high-temperature steam 222 condenses as soon as the high-temperature water steam 222 comes into contact with a cool condensation region 223. Condensation enables heat to be transferred to the metal base 22 and the heat-dissipating fins 30 via the carbon composite layer 21 and ultimately released to the ambient environment. A liquid-phase fluid 224 produced as a result of condensation returns to the bottom (above the heat-generating source) by means of the capillarity of the porosity structure 214 of the carbon composite layer 21. The above cycle continually repeats and thereby effectuates quick, efficient heat dissipation.

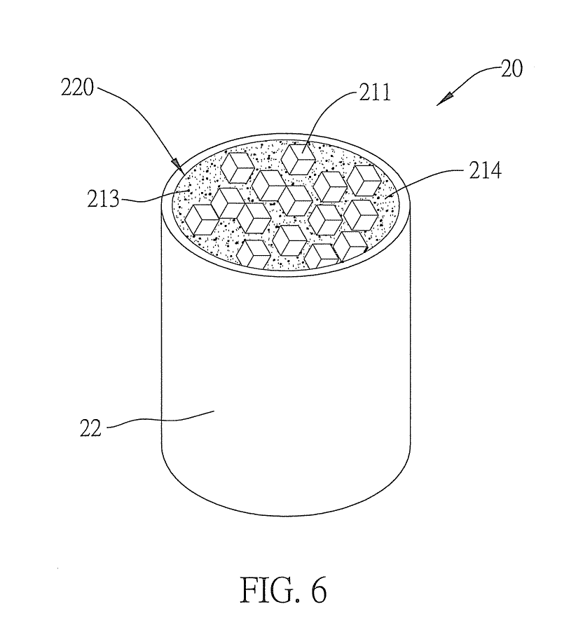

FIG. 6 depicts a perspective view of a fourth embodiment of the heat-dissipating structure according to the present invention. As shown in the drawing, the metal base 22 of the heat-dissipating structure 20 of the present invention is a cylinder, and it is formed therein with a cylindrical chamber 220. A plurality of carbon composite layers 21 are put in the chamber 220 and then sintered together to form a heat-dissipating structure 20 having a porosity structure 214. Also, the carbon composite layers 21 comprise the plurality of carbon particles 211 and the plurality of metal particles 213 to thereby provide a porous carbon-based composite structure which, coupled with the flow of fluid (air or water), enhances heat dissipation. In addition to a cylindrical shape, the metal base 22 may assume any other shape as needed.

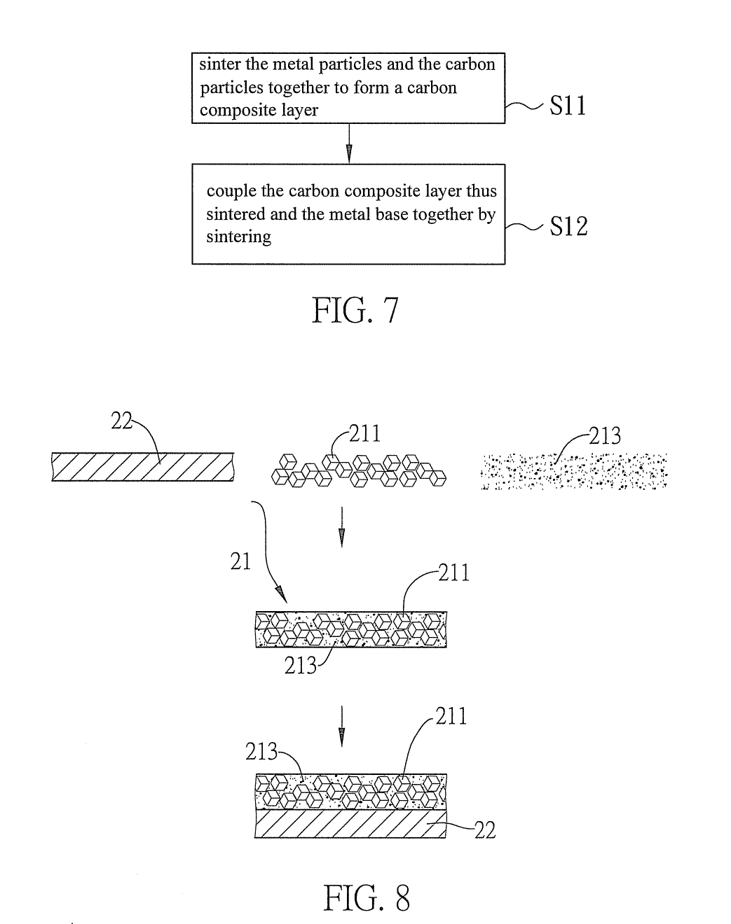

Referring to FIG. 7 and FIG. 8, a flow chart and a block diagram are provided of a method for fabricating the heat-dissipating structure according to the present invention. The method comprises the steps of:

Step S11: sintering the plurality of metal particles 213 and the plurality of carbon particles 211 together to form the carbon composite layer 21. Then, proceed to step S12.

Step S12: coupling the carbon composite layer 21 thus sintered and the metal base 22 together by sintering.

In this embodiment, the carbon particles 211 are of irregular shape. Also, the volumetric ratio of the metal particles 213 to the carbon particles 211 is greater than 1, and the diametric ratio of the carbon particles 211 to the metal particles 213 is predetermined. Reference data for implementation of the aforesaid volumetric ratio and diametric ratio are already disclosed in the above description of the heat-dissipating structure 20 and thus are not repeated herein.

The carbon particles 211 are diamonds, and the metal particles 213 are made of copper, aluminum, silver, or nickel. The diameter of the carbon particles 211 ranges between 1 μm and 2 mm, preferably between 50 μm and 180 μm, and more preferably between 90 μm and 110 μm.

The sintering as disclosed in the above embodiments involves a sintering process that produces pores, including pressureless sintering, vacuum sintering, and microwave sintering, and takes place at below 1050° C. to avoid compromising or damaging the characteristics of the copper powder and diamond.

Carbon particles (diamond) and metal particles (copper) differ from each other in terms of melting point, coefficient of expansion, and chemical properties. Hence, carbon particles and metal particles cannot be directly melted and sintered. Hence, according to the present invention, factors in sintering carbon particles (diamond) and metal particles (copper) in the carbon composite layer include the ratio of diamond to copper powder in size (such as the predetermined diametric ratio of the metal particles to the carbon particles), shape of the diamond particles (such as the irregular shape of the carbon particles), and volume of diamond utilized (such as the fact that the volumetric ratio of the metal particles to the carbon particles is greater than 1). The following experimental embodiments are described hereunder and illustrated with drawings.

### Experimental Embodiment 1

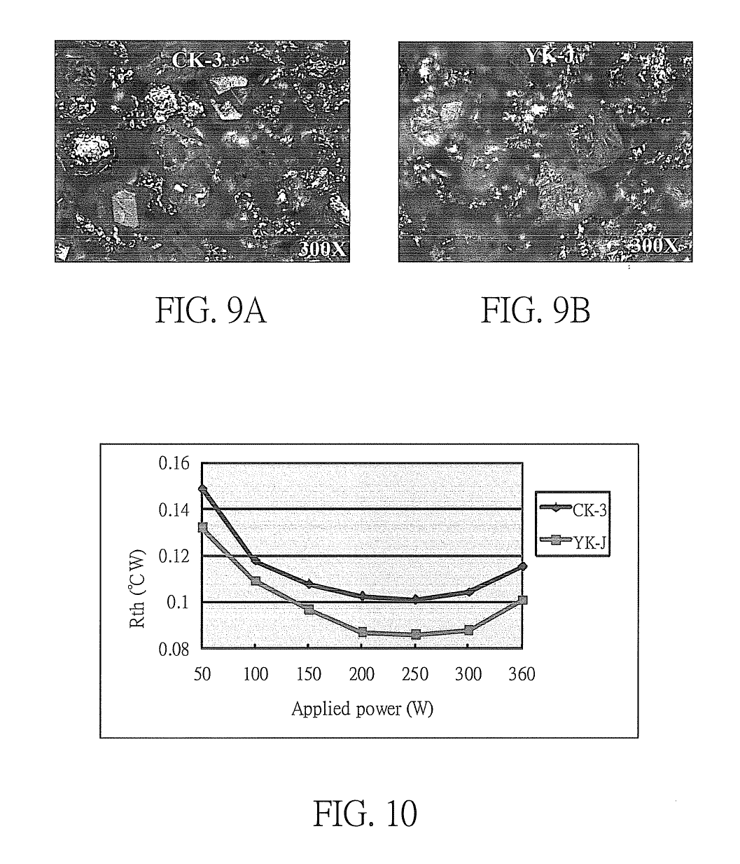

Copper powder with 70-150 mesh and diamond particles with 80-100 mesh are used. The volumetric ratio of the copper particles to the diamond particles is 6:1. Referring to FIG. 9A and FIG. 9B, pictures of a carbon composite layer of a heat-dissipating structure according to the present invention are shown when the carbon composite layer is observed with an optical microscope with 300× magnifying power. As shown in the drawings, the diamond particles are products of the Taiwan-based Fine Abrasives Coating Technology (FACT), serial no. CK-3 (as shown in FIG. 9A) and serial no. YK-J (as shown in FIG. 9B). The CK-3 diamond particles have as-grown facets. Most of the as-grown facets of the CK-3 diamond particles are of perfect shape, and the remainder are of imperfect shape. The YK-J diamond particles are crushed and thus have facets of irregular shape. Since diamond and copper powder are immiscible, in order to form a porosity structure from the diamond and copper particles sintered together in the carbon composite layer of the heat-dissipating structure according to the present invention, it is necessary for the diamond particles to be fixed in position by the copper powder, so as to prevent the diamond particles from coming off the porosity structure during the tooling process of the diamond-copper composite structure. Owing to their irregularly shaped facets, the YK-J diamond particles are readily held in position by the copper powder when sintered and coupled thereto, and thus the YK-J diamond particles are less likely to come off the diamond-copper composite structure during the tooling process. Conversely, owing to their regularly shaped facets, the CK-3 diamond particles are unlikely to be held in position by the copper powder when sintered and coupled thereto, and thus the CK-3 diamond particles are more likely to come off the diamond-copper composite structure during the tooling process. Also, the thermal conductivity of a porous wick structure in the carbon composite layer (diamond-copper composite layer) increases with the number of diamonds, which means higher efficiency of the vapor chamber. Hence, given the same volumetric ratio of the wick structure, the thermal resistance of a composite layer comprising the CK-3 diamond particles undesirably exceeds that of a composite layer comprising the YK-J diamond particles, as shown in FIG. 10.

### Experimental Embodiment 2

To work efficiently, the porous wick structure inside the vapor chamber requires sufficient capillarity for taking in water and sending the water to the evaporation end, and it requires an appropriate degree of porosity for the return of cool water. Hence, the wick structure is usually configured to comprise copper powder of different diameters and shapes so as to strike a balance between capillarity and porosity. Positioned proximate to the condensation end, a portion of the wick structure must have large pores to allow steam to be condensed into water and to allow the water to quickly return to the evaporation end; hence, the pores at the condensation end-adjoined portion of the wick structure should not be close to each other. By contrast, an evaporation end-adjoined portion of the wick structure must have considerable capillarity for sending water from the condensation end to the evaporation end; hence, the pores at the evaporation end-adjoined portion of the wick structure should be close to each other. For the above reasons, the heat-dissipating structure, that is, the vapor chamber, of the present invention is provided with a wick structure of different porosity as described below. At the evaporation end, the copper powder and diamond particles, respectively consisting of fine copper powder with 150-325 mesh and diamond particles with 140-170 mesh, are sintered together to form a dense wick structure (the carbon composite layer). At the condensation end that requires large pores, a copper powder with 70-150 mesh and diamond particles with 80-100 mesh are sintered together to form a wick structure (the carbon composite layer) made of composite materials.

### Experimental Embodiment 3

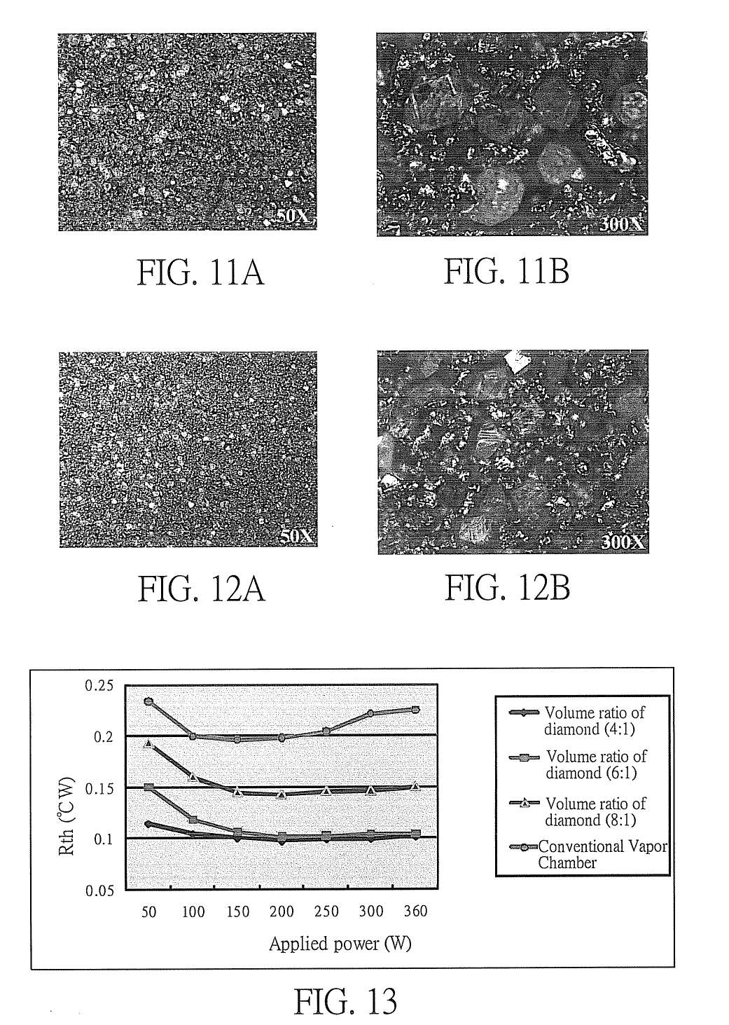

With diamond having a specific gravity of 3.52 and copper having a specific gravity of 8.9, the difference in the specific gravities thereof is significantly large. Also, the diamond particles differ from the copper powder in surface area. In this regard, a uniform mix and an appropriate difference in particle size are of vital importance. During the fabrication process of the wick structure, the uniform mixing of the diamond particles and copper powder is followed by filling a graphite die with powder. To allow the powder to have fine, dense pores after the sintering process and to enable tight control over the quality of the results, it is necessary to vibrate or shake the powder-filled graphite die so as to densify the powder. For instance, if the diamond particles are too large, upon vibration of the powder-filled graphite die, the diamond particles will separate from the copper powder, and thus the diamond particles cannot be held in position by the copper powder, thereby resulting in aborted sintering. If the diameter of the diamond particle is much less than that of the copper powder, upon vibration of the powder-filled graphite die, all the diamond particles will sink and end up underlying the copper powder, thus causing a lack of uniformity in the wick structure of the diamond-copper composite and leading to aborted sintering. Hence, the diametric ratio of the metal particles to the carbon particles is 1:1±15% and preferably 1:1±10%. The experimental embodiments involve using two kinds of copper powder, namely coarse copper powder with 70-150 mesh (observed with an optical microscope at 50× and 300× magnifying power, respectively, as shown in FIG. 11A and FIG. 11B) and fine copper powder with 150-325 mesh (observed with an optical microscopes at 50× and 300× magnifying power, respectively, as shown in FIG. 12A and FIG. 12B). The diamond particles (which are based on Taiwan-based FACT, serial no. YK-J) are described as follows: a coarse copper powder with a 70-150 mesh characterized by an average particle diameter of 0.175 mm, a 6:1 volumetric ratio of the metal particles to the carbon particles, and an optimal diamond particle size of 80-100 mesh (average particle size of 0.165 mm); and a fine copper powder with 150-325 mesh characterized by an average particle size of 0.090 mm, a 6:1 volumetric ratio of the metal particles to the carbon particles, and an optimal diamond particle size of 140-170 mesh (with an average particle size of 0.098 mm).

In another embodiment, the purpose of the experimental embodiment is to compare four vapor chambers of different structures, namely a vapor chamber formed by sintering only copper powder with a particle size of 70-150 mesh, and vapor chambers with different volumetric ratios (4:1, 6:1, 8:1) of the copper powder to the diamond particles but with the same copper powder particle size of 70-150 mesh. FIG. 13 is a graph plotting thermal resistance against input heat power for four vapor chambers made of different materials. As shown in the graph, with input heat power ranging from 50 W to 200 W, the thermal resistance of a vapor chamber formed from conventional fine copper powder reduces to 0.20° C./W from 0.23° C./W. Despite the initial reduction in thermal resistance, if the input heat power exceeds 250 W, the thermal resistance of the vapor chamber formed from copper powder solely will increase, indicating that the vapor chamber has dried out. The thermal resistance of a diamond-containing vapor chamber is always less than that of a vapor chamber formed from copper powder only. If the input heat power reaches 360 W, all the diamond-containing vapor chambers will dissipate heat in a stable manner, indicating that the vapor chambers are not dried out and thus are effective in dissipating heat from high-power electronic devices. Referring again to FIG. 13, the findings of the experimental embodiment are as follows: increasing the diamond content in a vapor chamber reduces the associated thermal resistance but causes more diamond particles to come off during the tooling process; if the diametric ratio of the copper powder to the diamond particles is less than 2:1 or even equal to 3:1, not only will many of the diamond particles come off the wick structure, but also the wick structure will be unstable; hence, the diametric ratio of the copper powder to the diamond particles is preferably 6:1.

In conclusion, unlike the prior art, the present invention provides a heat-dissipating structure comprising a plurality of metal particles and carbon particles sintered together to thereby provide a porosity structure between the carbon particles with a view to enhancing fluid heat transfer and heat dissipation. A method for fabricating a heat-dissipating structure according to the present invention involves sintering a plurality of metal particles and carbon particles together to thereby provide the porosity structure between the carbon particles, thus making good use of the high thermal conductivity of the carbon particles to enhance heat dissipation, and dispensing with precise control of temperature and pressure to thereby streamline the fabrication process and cut production costs. Last but not least, the heat-dissipating structure and the constituent elements thereof according to the present invention are structurally simple. Accordingly, a heat-dissipating structure and a method for fabricating the same according to the present invention overcome various drawbacks of the prior art and thereby have high industrial applicability.

The foregoing descriptions of the detailed embodiments are provided to illustrate and disclose the features and functions of the present invention and are not intended to be restrictive of the scope of the present invention. It should be understood by those in the art that many modifications and variations can be made according to the spirit and principles in the disclosure of the present invention and yet still fall within the scope of the invention as set forth in the appended claims.

What is claimed is:

1. A heat-dissipating structure, comprising:
a carbon composite layer comprising a plurality of metal particles and carbon particles sintered together, wherein:
the carbon particles are of irregular shape;
a volumetric ratio of the metal particles to the carbon particles is greater than 1; and
a diametric ratio of the carbon particles to the metal particles is predetermined.

2. The heat-dissipating structure of claim 1, wherein the volumetric ratio of the metal particles to the carbon particles ranges between 4:1 and 8:1.

3. The heat-dissipating structure of claim 2, wherein the volumetric ratio of the metal particles to the carbon particles is preferably 6:1.

4. The heat-dissipating structure of claim 1, wherein the predetermined diametric ratio of the metal particles to the carbon particles is 1:1±15%.

5. The heat-dissipating structure of claim 4, wherein the predetermined diametric ratio of the metal particles to the carbon particles is preferably 1:1±10%.

6. A heat-dissipating structure, comprising:
a metal base; and
a carbon composite layer formed above the metal base and comprising a plurality of metal particles and carbon particles sintered together with a porosity structure formed therebetween, wherein:
the carbon particles are of irregular shape;
a volumetric ratio of the metal particles to the carbon particles is greater than 1; and
a diametric ratio of the carbon particles to the metal particles is predetermined.

7. The heat-dissipating structure of claim 6, wherein the volumetric ratio of the metal particles to the carbon particles ranges between 4:1 and 8:1.

8. The heat-dissipating structure of claim 7, wherein the volumetric ratio of the metal particles to the carbon particles is preferably 6:1.

9. The heat-dissipating structure of claim 6, wherein the predetermined diametric ratio of the metal particles to the carbon particles is 1:1±15%.

10. The heat-dissipating structure of claim 9, wherein the predetermined diametric ratio of the metal particles to the carbon particles is preferably 1:1±10%.

11. A heat-dissipating structure, comprising:
a metal base having a chamber formed therein; and
a carbon composite layer comprising a plurality of metal particles and carbon particles sintered together, the carbon composite layer being formed on an inner wall of the chamber of the metal base, wherein:
the carbon particles are of irregular shape;
a volumetric ratio of the metal particles to the carbon particles is greater than 1; and
a diametric ratio of the carbon particles to the metal particles is predetermined.

12. The heat-dissipating structure of claim 11, wherein the volumetric ratio of the metal particles to the carbon particles ranges between 4:1 and 8:1.

13. The heat-dissipating structure of claim 12, wherein the volumetric ratio of the metal particles to the carbon particles is preferably 6:1.

14. The heat-dissipating structure of claim 11, wherein the predetermined diametric ratio of the metal particles to the carbon particles is 1:1±15%.

15. The heat-dissipating structure of claim 14, wherein the predetermined diametric ratio of the metal particles to the carbon particles is preferably 1:1±10%.

16. The heat-dissipating structure of claim 1, 6 or 11, wherein the metal particles are made of a material selected from the group consisting of copper, aluminum, silver, and nickel.

17. The heat-dissipating structure of claim 1, 6 or 11, wherein the carbon particles are diamonds.

18. The heat-dissipating structure of claim 6 or 11, wherein the carbon composite layer is coupled to the metal base by sintering.

19. The heat-dissipating structure of claim 1, 6 or 11, wherein the carbon particles are of a diameter between 1 μm and 2 mm.

20. The heat-dissipating structure of claim 19, wherein the carbon particles are of a diameter between 50 μm and 180 μm.

21. The heat-dissipating structure of claim 20, wherein the carbon particles are of a diameter between 90 μm and 110 μm.

22. A method for fabricating a heat-dissipating structure, comprising the steps of:
sintering a plurality of metal particles and a plurality of carbon particles together to form a carbon composite layer; and
coupling the carbon composite layer thus sintered and a metal base together by sintering, wherein:
the carbon particles are of irregular shape;
a volumetric ratio of the metal particles to the carbon particles is greater than 1; and
a diametric ratio of the carbon particles to the metal particles is predetermined.

23. The method of claim 22, wherein the volumetric ratio of the metal particles to the carbon particles ranges between 4:1 and 8:1.

24. The method of claim 23, wherein the volumetric ratio of the metal particles to the carbon particles is preferably 6:1.

25. The method of claim 22, wherein the predetermined diametric ratio of the metal particles to the carbon particles is 1:1±15%.

26. The method of claim 25, wherein the predetermined diametric ratio of the metal particles to the carbon particles is preferably 1:1±10%.

27. The method of claim 22, wherein the carbon particles are diamonds.

28. The method of claim 22, wherein the carbon particles are of a diameter between 1 μm and 2 mm.

29. The method of claim 28, wherein the carbon particles are of a diameter between 50 μm and 180 μm.

30. The method of claim 29, wherein the carbon particles are of a diameter between 90 μm and 110 μm.

31. A heat-dissipating structure, comprising:
a metal base having a chamber formed therein; and
a carbon composite layer comprising a plurality of metal particles and carbon particles sintered together, the carbon composite layer being provided therein with a porosity structure formed in the chamber of the metal base, wherein:
the carbon particles are of irregular shape;
a volumetric ratio of the metal particles to the carbon particles is greater than 1; and
a diametric ratio of the carbon particles to the metal particles is predetermined.

32. The heat-dissipating structure of claim 31, wherein the volumetric ratio of the metal particles to the carbon particles ranges between 4:1 and 8:1.

33. The heat-dissipating structure of claim 32, wherein the volumetric ratio of the metal particles to the carbon particles is preferably 6:1.

34. The heat-dissipating structure of claim 31, wherein the predetermined diametric ratio of the metal particles to the carbon particles is 1:1±15%.

35. The heat-dissipating structure of claim 34, wherein the predetermined diametric ratio of the metal particles to the carbon particles is preferably 1:1±10%.
